(19) United States
(12) Patent Application Publication
(10) Pub. No.: US 2014/0008018 A1
(43) Pub. Date: Jan. 9, 2014

(54) Process for the manufacture of impregnated cloths for composite articles

(71) Applicant: Audrey Di Martino, Decines (FR)

(72) Inventor: Audrey Di Martino, Decines (FR)

(73) Assignee: RHODIA OPERATIONS, Aubersvilliers (FR)

(21) Appl. No.: 14/006,366

(22) PCT Filed: Mar. 23, 2012
(86) PCT No.: PCT/EP2012/055200

§ 371 Date: Sep. 20, 2013

(30) Foreign Application Priority Data
Mar. 23, 2011 (FR) 1152398

(51) Int. Cl. B05D 3/02; B32B 5/28; B32B 37/18; B29C 51/00; B05D 7/24; B32B 37/12

(52) U.S. Cl. CPC B05D 3/0254; B05D 7/24; B32B 37/1284; B32B 37/18; B29C 51/004; B32B 5/28
USPC 156/306.6; 427/195; 427/185; 156/325; 264/320; 442/59; 428/221

(57) ABSTRACT

The present invention relates to the use of polyamide of high melt flow in the form of particles having a specific median diameter D50 in the manufacture of impregnated cloths used in the manufacture of composite materials. The field of the invention is that of composite materials and their processes of manufacture.

The present invention relates to the use of polyamide of high melt flow in the form of particles having a specific median diameter D50 in the manufacture of impregnated cloths used in the manufacture of composite materials. The field of the invention is that of composite materials and their processes of manufacture.

### PRIOR ART

In the field of high performance materials, composites have assumed a dominating position, in particular because of their performance and the savings in weight which they allow. The currently best-known high performance composites are obtained from thermosetting resins, use of which is limited to small-scale to moderate-scale applications, mainly in aeronautics or motor sports, and, in the best cases, which exhibit manufacturing times in the region of approximately fifteen minutes, such as, for example, during the manufacture of skis. The cost of these materials and/or the manufacturing times make it difficult to render them compatible with use in mass production. Furthermore, the use of thermosetting resins often involves the presence of solvents and of monomers. Finally, these composites are difficult to recycle.

One response, in regard to the manufacturing times, is given by composites comprising a thermoplastic matrix. Thermoplastic polymers are generally known for their high viscosity, which constitutes a check as regards the impregnation of the reinforcing materials, generally composed of very dense multifilament bundles. The use of the thermoplastic matrices available on the market results in a difficulty in impregnation, requiring either prolonged impregnation times or significant processing pressures. In the majority of cases, the composite materials obtained from these matrices may exhibit microspaces and unimpregnated regions. These microspaces bring about declines in mechanical properties, premature ageing of the material and problems of delamination when the material is composed of several reinforcing layers. This phenomenon of loss of mechanical properties is furthermore accentuated when the cycle times for the manufacture of the composite articles decrease.

It is known to use polyamides of high melt flow to increase the impregnation of the reinforcing cloths in the manufacture of composite articles comprising continuous fibres.

It is also known to impregnate the reinforcing cloths with powder formed of thermoplastic materials which are conventionally dusted over the said cloths. The powdered cloth then passes through a heating zone in which the powder reaches a sufficient temperature, at a temperature equal to or greater than that of its melting point, for it to be partially or completely liquefied and to impregnate the cloth on solidifying. However, the use of powders is restrictive in an industrial process for the manufacture of impregnated cloths. This is because the manufacture of powder is expensive and requires particular attention as regards the drying. Such a drying can require fairly intensive and lengthy heating. The use of powder in this process thus does not make it possible to carry out a more integrated and intensified process.

The object of the present invention is thus to overcome, in all or part, these disadvantages by providing a process for the manufacture of impregnated cloths which makes it possible to obtain composite articles which can be manufactured with short cycle times while having good use properties, such as good mechanical properties.

### INVENTION

The Applicant Company has discovered, unexpectedly, that the use of polyamides of high melt flow in the form of particles exhibiting a specific median diameter D50 in the impregnation of reinforcing cloths makes it possible to obtain impregnated cloths and also composite articles exhibiting good mechanical properties, such as in particular stiffness, ultimate strength, impact strength and fatigue behaviour, even when they are manufactured with shorter cycle times than those normally used and without any other treatment, in particular in terms of drying by heating and of protection from moisture of the polyamide particles. This makes it possible to provide a composite material exhibiting an advantage of reduction in manufacturing costs, by the use of equipment employing shortened cycle times.

The articles according to the invention exhibit in particular the advantages of stiffness, lightness and ability to be recycled, and a good surface appearance.

A first subject-matter of the invention is a process for the manufacture of an impregnated cloth comprising at least:
a) bringing together at least one reinforcing cloth and particles exhibiting a median diameter D50 of between 0.3 and 2 mm; the said particles are obtained from a polyamide composition exhibiting a melt viscosity of between 0.5 and 50 Pa·s, the latter being measured on the Newtonian plateau at a shear rate of 100 s⁻¹ in a capillary rheometer at a temperature of 25° C. above the melting point of the polyamide composition;
b) heating the mixture obtained in stage a) to a temperature which makes possible the at least partial melting of the particles; and
c) recovering the impregnated cloth.

Very particularly, the process does not comprise a preliminary stage of drying the particles by heating and/or under vacuum, in particular for more than one hour, nor the preservation in sealed containers, in particular with a view to preventing the uptake of water by the polyamide particles and making it possible to preserve the water content of the particles, as may be necessary in the case of the powders.

The particles can be dried by solely mechanical treatments, such as centrifuging or filtration, and preserved without specific protection, in particular in bags which are not watertight, before implementing the process.

The use of such particles thus makes it possible to result in a process which is shorter and integrated between the production of the particles and their use and/or renders the preservation procedures much easier.

The present invention relates to an impregnated cloth capable of being obtained by the process of the invention.

The invention also relates to the use of particles exhibiting a median diameter D50 of between 0.3 and 2 mm; the said particles are obtained from a polyamide composition exhibiting a melt viscosity of between 0.5 and 50 Pa·s, the latter being measured on the Newtonian plateau at a shear rate of 100 s⁻¹ in a capillary rheometer at a temperature of 25° C. above the melting point of the polyamide composition; for the impregnation of a reinforcing cloth.

Very particularly, these particles can be used without being subjected to drying by heating and/or under vacuum, in particular for several hours, indeed even without any heating and/or treatment under vacuum at all, and/or without requiring watertight packaging, before use, which allows the particles to remain at low water contents, in particular of less than 3000 ppm. In other words, it may be possible for the particles not to be stored in a dry atmosphere.

In particular, the composition can exhibit a melt viscosity ranging from 5 to 50 Pa·s, especially from 10 to 50 Pa·s. Such viscosities can make possible easier preparation of the particles according to the invention.

Cloth is understood to mean a textile surface obtained by assembling yarns or fibres which are rendered integral by any process, such as, in particular, adhesive bonding, felting, braiding, weaving or knitting. These cloths are also denoted as fibrous or filamentary networks. Yarn is understood to mean a monofilament, a continuous multifilament yarn or a staple fibre yarn obtained from fibres of a single type or from several types of fibres as an intimate mixture. The continuous yarn can also be obtained by assembling several multifilament yarns. Fibre is understood to mean a filament or a combination of filaments which are cut, cracked or converted.

The reinforcing yarns and/or fibres according to the invention are preferably chosen from yarns and/or fibres formed of carbon, glass, aramids, polyimides, flax, hemp, sisal, coir, jute, kenaf and/or their mixture. More preferably, the reinforcing cloths are composed solely of reinforcing yarns and/or fibres chosen from yarns and/or fibres formed of carbon, glass, aramids, polyimides, flax, hemp, sisal, coir, jute, kenaf and/or their mixture.

These cloths preferably have a grammage, that is to say weight per square metre, of between 100 and 1000 g/m².

Their structure may be random, unidirectional (1D) or multidirectional (2D, 2.5D, 3D or other).

Median diameter D50 is understood to mean the median which separates the curve of particle size distribution by volume into two parts of equal areas. The particle size analyses can be carried out using a Mastersizer X laser diffraction particle sizer having an extensive optical bench from Malvern Instruments S.A., making it possible to characterize particle sizes of between 2 and 2000 μm. As the distribution is by volume, the median diameter will correspond to 50% of the total volume of the particles. Furthermore, the given median diameter corresponds to the diameter of an equivalent sphere, it being assumed that all the objects have a shape equivalent to a sphere.

The melt viscosity is measured on the Newtonian plateau at a shear rate of 100 s⁻¹ in a capillary rheometer at a temperature of 25° C. above the melting point of the polyamide composition. The measurement is carried out so that the water content corresponds to the water content at equilibrium of the polyamide tested. It is possible in particular to measure the melt viscosity starting from granules of the polyamide composition.

The polyamide composition according to the invention comprises at least one polyamide.

The composition preferably comprises a polyamide exhibiting a number-average molecular weight Mn of greater than 8000 g/mol, more preferably of between 8000 and 20 000 g/mol, having satisfactory mechanical properties and a degree of hold during the various shaping processes.

Aliphatic or semi-aromatic semicrystalline polyamides are particularly preferred.

The polyamides can be chosen from the group consisting of polyamides obtained by polycondensation of at least one linear aliphatic dicarboxylic acid with an aliphatic or cyclic diamine or between at least one aromatic dicarboxylic acid and an aliphatic or aromatic diamine, polyamides obtained by polycondensation of at least one amino acid or lactam with itself, or their blend and (co)polyamides.

The polyamide of the invention is chosen in particular from the group consisting of polyamides obtained by polycondensation of at least one aliphatic dicarboxylic acid with an aliphatic or cyclic diamine, such as PA 6.6, PA 6.10, PA 6.12, PA 12.12, PA 4.6 or MXD 6, or between at least one aromatic dicarboxylic acid and an aliphatic or aromatic diamine, such as polyterephthalamides, polyisophthalamides or polyaramids, or their blend and (co)polyamides. The polyamide of the invention can also be chosen from polyamides obtained by polycondensation of at least one amino acid or lactam with itself, it being possible for the amino acid to be generated by the hydrolytic opening of a lactam ring, such as, for example, PA 6, PA 7, PA 11 or PA 12, or their blend and (co)polyamides.

Polyamides of high melt flow can in particular be obtained by controlling their molecular weight during the synthesis thereof, in particular by the addition, before or during the polymerization of the polyamide monomers, of monomers which modify the length of the chains, such as, in particular, diamines, dicarboxylic acids, monoamines and/or monocarboxylic acids. It is also possible to add polyfunctional compounds to the polymerization.

Polyamides according to the invention can also be obtained by blending, in particular melt blending, polyamides with monomers which modify the length of the chains, such as, in particular, diamines, dicarboxylic acids, monoamines and/or monocarboxylic acids.

The composition of the invention can also comprise copolyamides derived in particular from the above polyamides or blends of these polyamides or (co)polyamides.

Use may also be made, as polyamide of high melt flow, of a star polyamide comprising star macromolecular chains and, if appropriate, linear macromolecular chains.

The polyamide possessing a star structure is a polymer comprising star macromolecular chains and, optionally, linear macromolecular chains. The polymers comprising such star macromolecular chains are, for example, described in the documents FR 2 743 077, FR 2 779 730, EP 0 682 057 and EP 0 832 149. These compounds are known to exhibit an improved melt flow in comparison with linear polyamides.

The star macromolecular chains comprise a core and at least three polyamide branches. The branches are bonded to the core by a covalent bond, via an amide group or a group of another nature. The core is an organic or organometallic chemical compound, preferably a hydrocarbon compound optionally comprising heteroatoms and to which the branches are connected. The branches are polyamide chains. The polyamide chains constituting the branches are preferably of the type of those obtained by polymerization of lactams or amino acids, for example of polyamide-6 type.

The polyamide possessing a star structure according to the invention optionally comprises, in addition to the star chains, linear polyamide chains. In this case, the ratio by weight of the amount of star chains to the sum of the amounts of star chains and of linear chains is between 0.5 and 1, limits included. It is preferably between 0.6 and 0.9.

According to a preferred embodiment of the invention, the polyamide possessing a star structure, that is to say comprising star macromolecular chains, is obtained by copolymerization of a mixture of monomers comprising at least:

a) monomers of following general formula (I):

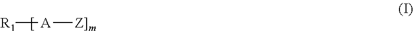

b) monomers of following general formulae (IIa) and (IIb):

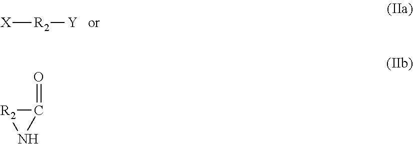

c) optionally monomers of following general formula (III):

Z—R₃—Z (III)

in which:
R₁ is a linear or cyclic and aromatic or aliphatic hydrocarbon radical comprising at least 2 carbon atoms which can comprise heteroatoms,
A is a covalent bond or an aliphatic hydrocarbon radical which can comprise heteroatoms and which comprises from 1 to 20 carbon atoms,
Z represents a primary amine functional group or a carboxylic acid functional group,
Y is a primary amine functional group when X represents a carboxylic acid functional group or Y is a carboxylic acid functional group when X represents a primary amine functional group,
R₂ and R₃, which are identical or different, represent substituted or unsubstituted and aliphatic, cycloaliphatic or aromatic hydrocarbon radicals comprising from 2 to 20 carbon atoms which can comprise heteroatoms,
m represents an integer between 3 and 8.

Carboxylic acid is understood to mean carboxylic acids and their derivatives, such as acid anhydrides, acid chlorides or esters.

Processes for producing these star polyamides are described in the documents FR 2 743 077 and FR 2 779 730. These processes result in the formation of star macromolecular chains, as a mixture with, optionally, linear macromolecular chains.

If a comonomer of formula (III) is used, the polymerization reaction is advantageously carried out until thermodynamic equilibrium is reached.

The monomer of formula (I) can also be blended with a molten polymer during an extrusion operation.

Thus, according to another embodiment of the invention, the polyamide possessing a star structure is obtained by melt blending, for example using an extrusion device, a polyamide of the type of those obtained by polymerization of lactams and/or amino acids and a monomer of formula (I). Such preparation processes are described in Patents EP 0 682 070 and EP 0 672 703.

According to a specific characteristic of the invention, the R₁ radical is either a cycloaliphatic radical, such as the tetravalent cyclohexanonyl radical, or a 1,1,1-propanetriyl or 1,2,3-propanetriyl radical. Mention may be made, as other R₁ radicals suitable for the invention, by way of example, of substituted or unsubstituted trivalent phenyl and cyclohexanyl radicals, tetravalent diaminopolymethylene radicals with a number of methylene groups advantageously of between 2 and 12, such as the radical originating from EDTA (ethylenediaminetetraacetic acid), octavalent cyclohexanonyl or cyclohexadionyl radicals, and the radicals originating from compounds resulting from the reaction of polyols, such as glycol, pentaerythritol, sorbitol or mannitol, with acrylonitrile.

Advantageously, at least two different R₂ radicals can be employed in the monomers of formula (II).

The A radical is preferably a methylene or polymethylene radical, such as the ethylene, propylene or butylene radicals, or a polyoxyalkylene radical, such as the polyoxyethylene radical.

According to a specific embodiment of the invention, the number m is greater than or equal to 3 and advantageously equal to 3 or 4.

The reactive functional group of the polyfunctional compound represented by the symbol Z is a functional group capable of forming an amide functional group.

Preferably, the compound of formula (I) is chosen from 2,2,6,6-tetra(β-carboxyethyl)cyclohexanone, trimesic acid, 2,4,6-tri(aminocaproic acid)-1,3,5-triazine and 4-aminoethyl-1,8-octanediamine.

The mixture of monomers which is the source of the star macromolecular chains can comprise other compounds, such as chain-limiting agents, catalysts or additives, such as light stabilizers or heat stabilizers.

The polyamide composition according to the invention can also comprise all the additives and fillers normally used in polyamide-based compositions used for the manufacture of articles. Thus, mention may be made, as examples of additives, of heat stabilizers, light stabilizers, antioxidants, lubricants, pigments, dyes, plasticizers, reinforcing fillers and agents which modify the impact strength.

Additives for improving the quality of the reinforcing cloths/polyamide interfaces can also be used. These additives can, for example, be incorporated in the polyamide composition, incorporated in the yarns and/or fibres of the reinforcing cloth, present on the yarns and/or fibres of the said cloth or deposited on the reinforcing cloth. These additives can be coupling agents, such as those of aminosilane or chlorosilane type, or liquefying or wetting agents, or their combination.

Reinforcing fillers can be incorporated in the polyamide composition. These fillers can be chosen from fibrous fillers, such as short glass fibres, for example, or non-fibrous fillers, such as kaolin, talc, silica, mica or wollastonite. Their size is generally between 1 and 50 μm. Submicronic, indeed even nanometric, fillers can also be used, alone or in supplementing the other fillers.

The polyamide composition can optionally comprise a novolac resin. It can comprise one or more different types of novolac resin.

The term “novolac resin” is generally understood to mean a phenolic resin for which the formaldehyde/phenol ratio is less than 1, and which, for this reason, normally remains thermoplastic until it has been heated with an appropriate amount of a compound, for example formaldehyde or hexamethylenetetramine, capable of giving additional bonds and consequently of giving an infusible product.

Novolac resins are generally condensation products of phenolic compounds with aldehydes or ketones. These condensation reactions are generally catalysed by an acid or a base. The novolac resins generally exhibit a degree of condensation of between 2 and 15.

The phenolic compounds can be chosen, alone or as mixtures, from phenol, cresol, xylenol, naphthol, alkylphenols, such as butylphenol, tert-butylphenol or isooctylphenol, nitrophenol, phenylphenol, resorcinol or bisphenol A; or any other substituted phenol.

The aldehyde most frequently used is formaldehyde. However, use may be made of other aldehydes, such as acetaldehyde, paraformaldehyde, butyraldehyde, crotonaldehyde, glyoxal and furfural. Use may be made, as ketone, of acetone, methyl ethyl ketone or acetophenone. The aldehyde and/or the ketone can optionally carry another functional group, such as, for example, a carboxylic acid functional group. To this end, mention may in particular be made of glyoxylic acid or levulinic acid.

According to a specific embodiment of the invention, the novolac resin is a condensation product of phenol and formaldehyde.

The novolac resins used advantageously have a molecular weight of between 500 and 3000 g/mol, preferably between 800 and 2000 g/mol.

Mention may in particular be made, as commercial novolac resin, of the commercial products Durez®, Vulkadur® or Rhenosin®.

The composition according to the invention can comprise between 1% and 30% by weight of novolac resin, in particular from 1% to 25% by weight, with respect to the total weight of the composition.

Particles is understood to mean, according to the present invention, objects which can take various shapes, such as spherical, substantially spherical, quasi-spherical, polyhedral, ovoid and/or ellipsoidal shapes, and which can exhibit, at the surface, bumps or small cavities forming irregularities, generated by gas bubbles, for example. The particles can be microbeads, beads, aggregates, granules, agglomerates or others.

The particles of the invention can be manufactured in various ways. Mention may be made, for example, of the direct routes by polymerization in a dispersed medium, and the indirect routes, such as spray drying, solid post-condensation of powder, dissolution/precipitation, granulation under water and their combination. Polymerization in a dispersed medium is understood to mean several polymerization processes in which the reaction medium is “compartmentalized”, such as for emulsion, suspension and dispersion processes, whether they are direct, reverse, micro or macro. Spray drying is understood to mean the spraying of a mixture or not of polymer of low viscosity in the molten state, dried and optionally followed by a rise in viscosity, by post-condensation of powder, for example. In the dissolution/precipitation, there is dissolution of the polymer in a solvent under hot conditions, then precipitation by slow cooling.

It is also possible in particular to manufacture particles according to the invention by extrusion, as mentioned in Applications EP 1 797 141 and EP 2 004 751, which describe the use of an additive added to the polyamide, and making possible, after cooling of the composition, the disintegration of the polyamide dispersion.

Underwater pelletizing devices for the manufacture of substantially spherical particles starting from a molten polymer have been known for a very long time. Mention may be made, by way of examples, of U.S. Pat. No. 2,918,701 and U.S. Pat. No. 3,749,539. Furthermore, Application US2005/0035483 describes an underwater pelletizing process and device which make it possible to reduce the problems generated by feeding polymers having a high melting point and having a high rate of crystallization, such as polyamides. The latter process is particularly advantageous as it can make it possible to obtain particles exhibiting an excellent homogeneity in size, so much so that they can be described as monodisperse and/or exhibiting a good sphericity.

The particles thus produced are recovered by any known means, in particular by centrifuging, separation by settling or filtration. They are subsequently advantageously dried. They can also be subjected to treatments in order to modify some of their properties, such as the improvement in the mechanical properties by a heat treatment or a treatment with radiation in order to bring about the increase in the molecular weight of the polymer and/or its degree of crosslinking.

The particles of the present invention preferably exhibit a median diameter D50 of between 0.5 and 1.5 mm, in particular ranging from 0.8 to 1.5 mm. The particles can exhibit a D10, indeed even a D05, of greater than or equal to 0.5 mm, in particular of greater than or equal to 0.7 mm. The D10 and the D05 are equivalent to the D50 with respectively 10-90% and 05-95% instead of 50%.

The stage of impregnation, by a process of dry “powder” type, of the reinforcing cloth by the particles based on a polyamide composition can be carried out in various ways, according to various possible processes.

Mention may in particular be made, for example, of dusting and impregnation by passing through a fluidized bed, which is very widely documented, for the deposition of powders.

Impregnation on a fluidized bed is known to a person skilled in the art, in particular for the deposition of thermoplastic powders on a continuous reinforcing cable, and mention may be made, by way of example, of the studies by Shridhar R. Iyer and Lawrence T. Drzal; Manufacture of Powder-Impregnated Thermoplastic Composites; Journal of Thermoplastic Composite Materials, October 1990, vol. 3, 325-355, and U.S. Pat. No. 5,128,199 (PA12, diameter: 5-15 μm, bed fluidized by acoustic energy), J. P. Nunes, J. F. Silva, A. T. Marques, N. Crainic and S. Cabral-Fonseca; Production of Powder-Coated Towpregs and Composites; Journal of Thermoplastic Composite Materials, May 2003, vol. 16, No. 3, 231-248, and WO2002006027 A1 (PP, D50 weight=400 μm, bed fluidized by recirculation), U.S. Pat. No. 5,057,338 (Polyimide, diameter: 19 μm, bed fluidized by recirculation), EP 1 281 498 (PA6, diameter: 20-400 μm, fluidized bed and electrostatic charge). Baucom R. M. and Marchello J. M.; Powder curtain prepreg process; 38th International SAMPE Symposium, May 10-13, 1993, Proceedings, pp 1902-1915, also provide for the use of a coating system which makes it possible to deposit a “curtain” of powder over the reinforcing cable, spread as a “machine width” with a width of approximately ten centimetres. For continuous reinforcing cloths with a machine width of greater than 1 m, the use of a fluidized bed is no longer appropriate and a person skilled in the art will naturally turn towards powdering or dusting.

By way of example, a dusting module makes it possible to deposit, by gravity, the dry powder over the continuous reinforcing cloth, which moves forward at a constant rate under the hopper of the dusting module. The said hopper is equipped with a structured or unstructured roller, equipped or not equipped with a specific covering, which makes possible uniform and controlled deposition, without direct contact with the cloth. A scraping element, in contact with the dusting roller, removes excess powder during the rotation and makes it possible to retain solely the amount of powder necessary in the cavities of the covering. An oscillating brush extracts the powder from the dusting roller. In order to guarantee uniformity of take up of the powder and to break down the aggregates, the powder falls according to its consistency through an oscillating sieve and then—without contact—onto the moving cloth to be dusted. The very precise amount of powder taken up is obtained by adjustable automatic control of the rotation of the roller. Use may be made of the same dusting technology used in the field of powder deposition to carry out dusting of the granules over the reinforcing cloth.

It is also possible to preheat the reinforcing cloth, so that the particles come into contact with a cloth exhibiting a temperature of less than or equal to the melting point of the polyamide particles.

The mixture obtained in stage a) is then heated, so that the particles are at least partially, preferably at least 50% by weight, more preferably at least 90% by weight, melted. The cloth comprising the particles can, for example, pass through a heating zone.

The heat can be introduced by circulation of hot air, in particular by gas or fuel oil burners, by electrical resistances, by microwaves or by infrared heating.

It is preferable to heat the mixture at a temperature of between 230° C. and 350° C.

After the impregnation of the reinforcing cloth by the polyamide, the impregnated cloth is obtained by solidification of the matrix. The cooling can advantageously be carried out rapidly, so as to prevent significant crystallization of the polyamide, in particular in order to maintain the properties of the article. The cooling can in particular be carried out in less than 5 minutes, more preferably in less than one minute, for example by a cold air circuit or by a fluid.

The impregnated cloths according to the invention preferably comprise:
from 40% to 70% by volume of reinforcing cloth, and
from 30% to 60% by volume of polyamide, with respect to the total volume of the impregnated cloth, optionally on both faces.

The impregnated cloths can be used as is, for example after a cutting and/or thermoforming stage. The impregnated cloths are also known as prepregs in the field of the manufacture of composite articles.

It is also possible to produce composite articles from these impregnated cloths.

The present invention also relates to the use of impregnated cloths as obtained above in the manufacture of composite articles; also known as continuous-fibre composite articles.

The invention also relates to a process for the manufacture of a composite article by stacking impregnated cloths comprising at least impregnated cloths as described above, preferably in a mould, at a temperature and a pressure which make it possible to melt the polyamide and to obtain a composite article. Use may also be made of impregnated cloths according to the invention and of other types of impregnated cloths. The present invention also relates to a composite article capable of being obtained by the process of the invention.

Furthermore, it is possible, for example, to carry out the thermoforming of the composite articles in the form of sheets in order to give them a defined shape after cooling. The invention thus relates to composite articles or preforms capable of being obtained by the process according to the present invention.

The articles of the invention can also be structures of sandwich type exhibiting a kernel inserted between two skins. The composites of the invention can be used to form external layers, by combining them with a kernel of honeycomb type or foam type. The layers can be assembled by chemical or heat bonding.

The composite structures according to the invention can be employed in numerous fields, such as the aeronautical, motor vehicle, electrical or sports and leisure industries. These structures can be used to produce sports equipment, such as skis, or else to produce various surfaces, such as special floors, partitions, vehicle bodies or billboards. In aeronautics, these structures are used in particular for fairings, such as for the fuselage, the wing and the tailplane. In the motor vehicle industry, they are used, for example, for floors or supports, such as parcel shelves.

A specific language is used in the description so as to facilitate understanding of the principle of the invention. Nevertheless, it should be understood that no limitation of the scope of the invention is envisaged by the use of this specific language. Modifications and improvements can in particular be envisaged by a person conversant with the technical field concerned on the basis of his own general knowledge.

The term and/or includes the meanings and, or and all the other possible combinations of the elements connected to this term.

Other details or advantages of the invention will become more clearly apparent in the light of the examples given below purely by way of indication.

### EXPERIMENTAL SECTION

The polyamide compositions comprise a linear PA 6.6 matrix, 20% by weight of the commercial novolac resin Rhenosin® and additives, such as light and heat stabilizers, as mentioned in Application WO2011003786. The composition exhibits a melting point of 255° C.
CPA1: Comparative composition of standard melt flow having a melt viscosity at 100 s⁻¹ of 114 Pa·s.
PA1: Composition of high melt flow having a melt viscosity at 100 s⁻¹ of 21 Pa·s.
PA2: Composition of very high melt flow having a melt viscosity at 100 s⁻¹ of 4 Pa·s.

The polyamide compositions based on PA 6.6 are characterized by their melt viscosity η measured via a capillary rheometer at 280° C., the value being measured on the Newtonian plateau at 100 s⁻¹.

The reinforcing cloth used is an 8-harness satin balanced (51/49) glass fabric with a grammage of 300 g/m² exhibiting a treatment compatible with thermoplastics.

### Comparative Example 1

### Manufacture of Composite Article from Powder

The various polyamide compositions based on polyamide 6.6 in the form of granules with a size of 2.5 mm are subjected to cryogenic grinding, which grinding can be carried out by different types of grinders, such as, for example, a disc mill, a hammer mill, a pin mill, or an electromagnetic mill, for example a piston mill. In this example, in order to obtain a powder with D50=150 μm, grinding with a Micronis twin-rotor pin mill is carried out at a temperature between −10° C. and −200° C., preferably between −20° C. and −100° C. After the grinding, it is possible to modify the particle size of the powder using rotary sieves or flat sieves having a gyratory movement. A controlled particle size, of less than 400 μm and exhibiting a D50 of 150 μm, is thus obtained. The fineness of the powder is known to promote good impregnation of the reinforcing cloth. The cryogenic grinding as defined above also makes it possible to obtain a polyamide-based powder having a residual moisture content of less than or equal to 0.8% by weight (8000 ppm), on exiting from cryogenic grinding. An additional stage of drying by any technique known to a person skilled in the art is carried out in order to achieve a content of between 1000 and 3000 ppm. This drying can, for example, be carried out under vacuum or dry air, at a temperature of 80° C. The polyamide-based powder can subsequently be placed in a sealed bag, so as to preserve its moisture content until it is used. In order to determine the moisture content of a polyamide-based powder, use may be made of the Fischer method according to Standard ISO 15512 1999 (F), method B.

The dry powder is then ready to be deposited on the reinforcing cloths by a dry-route powder impregnation process.

The line used is composed of a unit for the unwinding of the reinforcing cloth, with an IR field used in particular in the case of carbon reinforcement, to preheat the reinforcement to a melting point equal to the melting point of the polyamide composition minus 20° C., with a dusting module associated with a metering hopper, with IR fields and with a winding unit.

The dusting module makes it possible to deposit, by gravity, the dry powder over the continuous reinforcing cloth, which moves forward at a constant rate under the hopper of the dusting module. The said hopper is equipped with a roller which makes possible uniform and controlled deposition, without direct contact with the cloth. A scraping element, in contact with the dusting roller, removes excess powder during the rotation and makes it possible to retain solely the amount of powder necessary in the cavities of the covering. An oscillating brush extracts the powder from the dusting roller. In order to guarantee uniformity of take up of the powder and to break down the aggregates, the powder falls according to its consistency through an oscillating sieve and then—without contact—onto the moving cloth to be dusted.

The powdered cloth subsequently passes through a heating zone made of downstream IR fields in which the powder reaches a sufficient temperature, at a temperature equal to or greater than that of the melting point of the composition, for it to be partially or completely liquefied and to impregnate the cloth on solidifying.

In this example, the rate of forward progression of the cloth is 10 m/min and the amount of composition based on linear PA 6.6 matrix is 72 g/m² for the first face. The temperature of the IR field with a length of 10 m is regulated at 300° C. in order to make possible the melting of the composition while avoiding the decomposition thereof. These stages are repeated in order to impregnate the other face of the cloth and to thus produce a glass/PA prepreg comprising 67% of reinforcement by weight, i.e. 48% by volume.

This prepreg is subsequently cut to the dimensions required for the manufacture of sheets, that is to say, in this example, 150×150 mm.

Composite sheets are prepared using a Schwabenthan (Polystat 300A) hydraulic press comprising two temperature-controlled plates: heating plates by heating resistances and plates cooled by circulation of water. A metal mould having a cavity with dimensions of 150 mm×150 mm is used.

The temperature of the plates of the press is increased beforehand to 90° C., before the introduction of the stack of 8 pre-pregs of 150×150 mm. At this temperature, an optimum pressure of 5 bar is applied and maintained for a cycle time of 5 minutes on the plate; venting operations can be rapidly carried out. The mould is then transferred onto the cooled plates device and maintained under pressure during the cooling.

The composite sheet is subsequently analysed in order to determine the impact of the defects, such as porosity, gaseous inclusions of highly variable shape, size and location, recognized by a person skilled in the art as being able to handicap the mechanical strength of the composite structure. These defects are due not only to the processing process but also to the ability of the composition to homogeneously impregnate the reinforcement. It is consequently understood why it becomes essential to take an interest in these porosities.

It is known that, below a certain percentage by volume of between 0.8% and 1.5%, depending on the material studied, the porosity has no influence on the behaviour of the part if it is isodistributed. On the other hand, for higher degrees of porosity, the mechanical properties of the part, in particular the compression, are significantly affected. For example, in the aeronautical industrial sphere, it is accepted that a structural part comprising a content of porosity by volume of greater than 2% has to be discarded.

The porosity is conventionally measured according to one of the techniques described in Standard ASTM D2734-94. It should only be noted that, for porosities of less than 1%, the levels of accuracy which the measurements of weight and volume necessary for the measurement have to achieve are not achievable; an error of 1% with regard to the values of the densities of the resin or of the matrix results in a modification of ±0.5% in absolute value with regard to the degree of porosity determined.

In the results Table 1, mention will thus only be made of a content of less than 1% when this is the case.

The mechanical compressive properties are obtained at 23° C. and for a humidity RH=50% (stabilization of the test specimens for 48 h at 23° C., RH=50) according to Standard ISO 14126:1999 (F). The test specimens are tested in compression according to Standard ISO 14126 on a Schenck RMC 100 electromechanical machine. The values for peak stresses σ max are measured and calculated. The experimental results are given in Table 1.

### Comparative Example 2

### Manufacture of Composite Article from Granules

The various compositions are directly shaped at the outlet of the extruder by virtue of the use of a coupled device for the granulation of rods. The granules have a size of 2.5 mm and are ready to be deposited without any other type of preparation.

The dusting device is identical to that described in Comparative Example 1, with an adjustment at the powdering roller, which is specifically structured to deposit the granules and which is equipped not with an oscillating brush but with a rotary brush, making it possible to extract the granules from the dusting roller and to guarantee uniformity of take up. As in Comparative Example 1, a glass/PA prepreg comprising 67% of reinforcement by weight, i.e. 48% by volume, is produced. This prepreg is subsequently cut to the dimensions required for the manufacture of sheets, which sheets are analysed in porosity and compression. The results are presented in Table 1.

### Example 1

### Manufacture of Composite Article from Particles

The various compositions are directly shaped at the outlet of the extruder by virtue of the use of a coupled device for underwater granulation having a thermal buffer technology which prevents the gelling of the extruded matrix in the holes of the die, by the ECON EUP 600 technology—US20100068324A1. The production of particles having the form of microbeads exhibiting a D50 of 1 mm is carried out with a flow rate of 500 kg/h. An in-line centrifugal dryer system makes it possible to separate the particles from the water of the cooling process and dries the particles until a residual moisture content well below 3000 ppm is obtained. The particles are ready to be deposited without any other type of preparation.

In the case of PA 2, a specific configuration of the extruder, in particular with respect to the cooling, can be used.

In comparison with Comparative Example 1, the grinding and drying stages are avoided, making it possible to carry out a more integrated and intensified process. Subsequently, the handling of particles is much less restrictive in terms of Health and Safety precautions for the operators, in comparison with powder and in particular very fine particles.

The dusting device is identical to that described in Comparative Example 1, with an adjustment at the powdering roller, which is specifically structured to deposit the particles. As in Comparative Example 1, a glass/PA prepreg comprising 67% of reinforcement by weight, i.e. 48% by volume, is produced. This prepreg is subsequently cut to the dimensions required for the manufacture of sheets. The sheets are then analysed in porosity and compression. The results are presented in Table 1.

### Presentation of the Results

All the results are presented in Table 1.

TABLE 1

| | | Comparative | Comparative | |
|---|---|---|---|---|
| | | Example 1 | Example 2 | Example 1 |
| Composition | Measurements | (powder) | (granules) | (microbeads) |
| CPA1 | Porosity | <1% | 6% to 10% | 4% |
| | Compression | 350 MPa | <200 MPa | 300 MPa |
| PA1 | Porosity | <1% | 2% to 4% | 1% |
| | Compression | 600 MPa | 200 MPa | 400 MPa |
| PA2 | Porosity | <1% | 1% to 2% | <1% |
| | Compression | 650 MPa | 350 MPa | 550 MPa |

The production of composite articles according to the invention is thus observed in Example 1 using polyamide compositions of high melt flow PA1 and PA2 exhibiting good mechanical properties and a low porosity, signs of an excellent impregnation of the polyamide composition on the reinforcing cloth. It will also be noted that these articles exhibit a very good surface appearance and an incomparable ease of use, due to the low melt viscosity of the polyamide composition.

These results are obtained without the use of powder as is nevertheless known in the state of the art, thus making it possible to avoid a restrictive and expensive grinding stage, which furthermore has to be followed by a drying stage. The use of powder in this process thus does not make it possible to carry out a more integrated and intensified process. Furthermore, the handling of granules is much less restrictive in terms of Health and Safety precautions for the operators, in comparison with powder.

Furthermore, it is observed that the use of granules of polyamide compositions for such an application is not in all cases advantageous from the viewpoint of the poor mechanical properties obtained.

1. A process for making an impregnated cloth, comprising:
a) bringing together at least one reinforcing cloth and particles exhibiting a median diameter D50 of between 0.3 and 2 mm, said particles comprising a polyamide composition that exhibits a melt viscosity of between 0.5 and 50 Pa·s, as measured on the Newtonian plateau at a shear rate of 100 s⁻¹ in a capillary rheometer at a temperature of 25° C. above the melting point of the polyamide composition;
b) heating the combined cloth and particles from stage a) to a temperature effective to at least partially melt the particles; and
c) recovering the impregnated cloth.

2. A process according to claim 1, wherein the polyamide composition comprises a polyamide exhibiting a number-average molecular weight Mn of greater than 8000 g/mol.

3. A process according to claim 1 wherein the polyamide composition comprises an aliphatic or semi-aromatic semicrystalline polyamide.

4. A process according to claim 1, wherein the polyamide composition comprises a novolac resin.

5. A process according to claim 4, wherein the polyamide composition comprises between 1% and 30% by weight of the novolac resin.

6. A process according to claim 1, wherein the particles exhibit a median diameter D50 of between 0.5 and 1.5 mm.

7. A process according to claim 1, wherein stage a) is carried out by dusting or impregnation by passing through a fluidized bed.

8. A process according to claim 1, wherein stage b) is carried out at a temperature of between 230° C. and 350° C.

9. A process according to claim 1, wherein the impregnated cloth comprises:
from 40% to 70% by volume of the reinforcing cloth, and
from 30% to 60% by volume of the polyamide composition,
with respect to the total volume of the impregnated cloth.

10. An impregnated cloth obtained by the process of claim 1.

11. (canceled)

12. A process for the manufacture of a composite article, comprising stacking impregnated cloths comprising at least one impregnated cloth according to claim 1, at a temperature and a pressure effective to melt the polyamide and to obtain a composite article.

13. A composite article made by the process according to claim 12.

14. (canceled)

15. A process according to claim 1, wherein the polyamide composition exhibits a melt viscosity of from 5 to 50 Pa·s.

16. A process for making an impregnated cloth, comprising bringing together at least one reinforcing cloth and particles exhibiting a median diameter D50 of between 0.3 and 2 mm; said particles being obtained from a polyamide composition that exhibits a melt viscosity of between 0.5 and 50 Pa·s, as measured on the Newtonian plateau at a shear rate of 100 s⁻¹ in a capillary rheometer at a temperature of 25° C. above the melting point of the polyamide composition.

17. The process of claim 12, further comprising thermoforming the composite article to obtain a shaped composite article.

18. The process of claim 12, further comprising making a second composite article and stacking a honeycomb or foam kernel between the two composite articles and bonding the stacked kernel and composite articles to form a lamellar composite structure.
